(19) United States
(12) Patent Application Publication
(10) Pub. No.: US 2023/0387556 A1
(43) Pub. Date: Nov. 30, 2023

(54) Busbar

(71) Applicant: TE Connectivity Germany GmbH, Bensheim (DE)

(72) Inventors: Michael Ludwig, Bensheim (DE); Isabell Buresch, Woert (DE)

(73) Assignee: TE Connectivity Germany GmbH, Bensheim (DE)

(21) Appl. No.: 18/325,340

(22) Filed: May 30, 2023

(30) Foreign Application Priority Data
May 30, 2022 (DE) 102022113518.7

(51) Int. Cl. H01M 50/524; H01B 7/42

(52) U.S. Cl. CPC H01M 50/524; H01M 50/503; H01B 7/421

(57) ABSTRACT

A busbar according to an embodiment includes an outer sheath enclosing a cavity and a metal foam contained in the cavity. A porosity formed within the metal foam is at least partially filled with a phase change material.

### CROSS-REFERENCE TO RELATED APPLICATION

This application claims the benefit of the filing date under 35 U.S.C. § 119(a)-(d) of German Patent Application No. 102022113518.7, filed on May 30, 2022.

### FIELD OF THE INVENTION

The present invention relates to a busbar with an outer sheath enclosing at least one cavity in which a phase change material is located.

### BACKGROUND

The present invention relates to the field of electromobility, in particular connections in the charging path and the battery, for example the lead-off or lead-in cable and cell connectors of electrically powered motor vehicles. In order to reduce the charging time for the batteries contained in these vehicles, the aim, particularly in the case of high-current charging, also known as High Power Charging (HPC), is to avoid derating of the charging current power triggered by current heating. This high-power charging requires an ever-increasing current flow from the power source, such as, for example, a charging station, to the user, i.e. the battery of the vehicle. As a result, the electrically conductive components are exposed to currents exceeding 500 A, which leads to resistance heating of the current-carrying components.

In order to reduce possible heating damage to the current conduction path extending from a charging contact element to or into a battery of a motor vehicle and its surroundings, the cross-sectional surface of the respective component can be enlarged so that the current density and the resulting heat generation are reduced. However, this leads directly to an increase in weight, the need for more space and the cost of the components. In order to dissipate the heat generated, the use of additional active cooling systems may also be necessary, although these entail similar disadvantages.

A cooling device for cooling battery cells of a battery for a motor vehicle is known. In this context, the cooling device is configured as a busbar arrangement with a phase change material (PCM) in a busbar for electrically connecting the poles of the battery cells. Closed channels are integrated into the busbar, which extend longitudinally along the busbar and contain a phase change material, which is adapted to extract heat from the busbar when a certain phase change temperature for the phase transition of the phase change material is exceeded.

When the phase change temperature is reached, further heating of the busbar is delayed because the heat generated is transferred to the phase change material and absorbed by it for the phase transition. Thus, the heat can be dissipated from the busbar and the temperature increase of the busbar can be stopped or delayed. However, such a structure limits the amount of phase change material which can be incorporated into the busbar without drastically reducing the current which the busbar can transmit, unless the busbar is dimensioned larger.

The underlying problem of the present invention is to provide a busbar which allows efficient cooling in a simple and compact structure without reducing the amount of current to be transmitted in the same geometric cross-section.

### SUMMARY

A busbar according to an embodiment includes an outer sheath enclosing a cavity and a metal foam contained in the cavity. A porosity formed within the metal foam is at least partially filled with a phase change material.

### BRIEF DESCRIPTION OF THE DRAWINGS

Exemplary embodiments of the invention are described by way of the following drawings. In the drawings:

FIG. 1 is a sectional perspective view of a pair of busbars; and

FIG. 2 is a sectional side view of one of the pair of busbars.

### DETAILED DESCRIPTION OF THE EMBODIMENT(S)

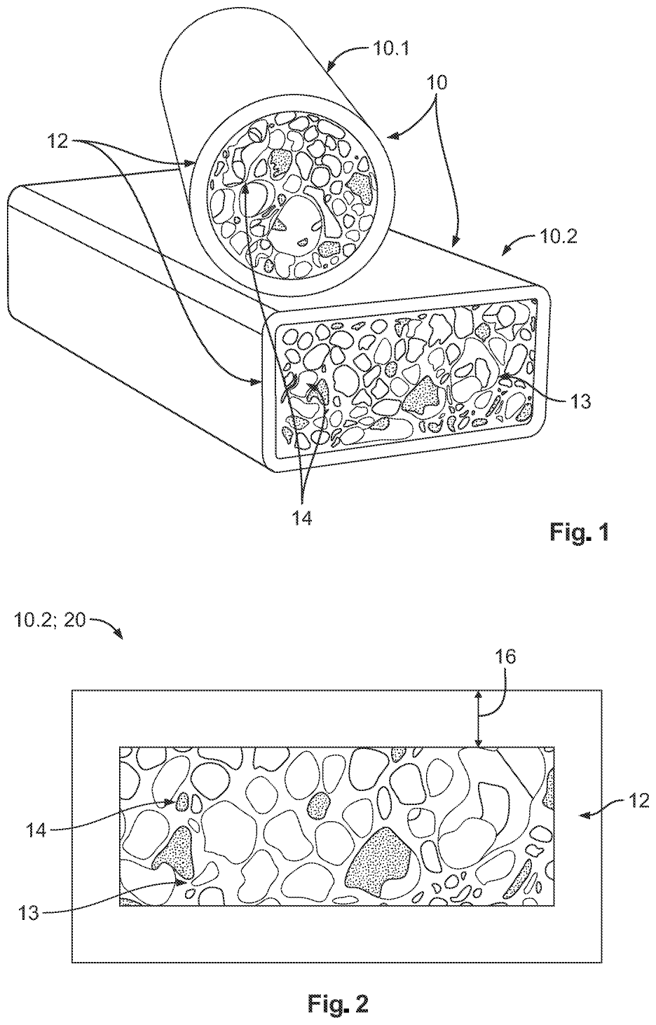

In FIGS. 1 and 2, reference sign 10 characterizes a busbar. In this context, a busbar 10 represents, in an embodiment, a rigid component made of an electrically conductive material which functions as a component of an electrical circuit and thus enables a connection between a power source and a load. Accordingly, a busbar according to the invention can also be configured as a modular connector or be provided with at least one screw connection or connection lug for connection to adjacent parts of the current conduction path. The busbar 10 can be installed in the current conduction path from a charging contact element of the vehicle to the battery or within the battery, for example to electrically connect different cells or modules. Usually, a busbar is an elongated body, the length of which is generally substantially greater than its diameter or equivalent diameter. Although the busbar is usually straight, it may also be curved or angled, such as at an obtuse angle. It is understood that the busbar 10 may also have a more flexible portion or element or be formed in such a manner, e.g., from a braided band or fabric band, to improve mounting of the busbar in the desired installation space.

A cross-sectional surface of the busbar 10, in an embodiment, is uniform along the entire length of the busbar 10 and may have any geometry; the shape of the cross-sectional surface of the busbar 10 may be rectangular, square, circular, or oval. As shown in FIG. 1, a busbar with a circular cross-section is characterized by reference number 10.1 and a busbar with a rectangular cross-section by reference number 10.2.

The busbar 10 has an outer sheath 12 enclosing at least one cavity 13 extending longitudinally along the busbar 10, in an embodiment extending along the entire length of the busbar 10. In an embodiment, the outer sheath 12 has a front end face and/or a rear end face, each of which is arranged perpendicular to the length of the busbar 10 and terminates the cavity 13 outwardly. The cavity 13 may be completely enclosed by the outer sheath 12. Irrespective of the cross-sectional geometry of the busbar 10.1, 10.2 described above, both have an outer sheath 12 which encloses a cavity 13 in which metal foam 14 with porosity is accommodated.

In an embodiment, the front and rear end faces of the busbar 10 have terminal lugs or solid pressed end-regions, which are provided with a special surface coating of Sn or Sn alloy, Ag or Ag alloy, Ni or Ni alloy with possible intermediate layers or adhesion promoters or surface structures. Contact is made with the charging inlet or the battery or battery cell via a screw connection or US-welding, for example.

The outer sheath 12 can be manufactured as a uniform component by a manufacturing process such as extrusion, however it is also possible to connect individual sheets or plates, each of which forms partial areas of the outer circumferential surface, by welding or soldering, for example, to form the busbar 10. The outer sheath 12 can also consist of a braided band or fabric band or of the connection of several braided bands or fabric bands. The outer sheath 12, which may also be formed of plastic, for example, may be manufactured as a shrink tube or by extrusion. Additionally, the inner surfaces of the outer sheath 12 which come into contact with the cavity 13 can be provided with a tin layer by technically customary tinning methods. The outer sheath 12 generally consists, at least partially, of a conductive metal alloy, e.g., on a copper or aluminum basis. It is understood that this includes the use of commercially and technically pure aluminum or copper materials. In particular, in the case of materials made of copper the addition of alloying elements can be reduced, if not avoided altogether. Alloying elements, such as oxygen, phosphorus, silicon, lithium, magnesium, boron; tin, chromium, zirconium and/or iron may be present in the selected material, however, below 3 wt %. Cu alloys which can be used for the outer sheath include, for example, C10200, C11000, C12200, C10100, among others. In terms of aluminum-based materials, pure aluminum alloy, ultra-pure aluminum with 99.99 wt % Al purity, alloys with magnesium and silicon, or alloys with zirconium may be used. Possible alloys are A1050, AW 5743, A1350, AW6101, among others.

The wall thickness 16 of the outer sheath 12, which may remain constant over the entire busbar 10, can be customized and selected depending on the desired weight, space requirements and/or the necessary current carrying capacity of the busbar 12. The wall thickness 16 of the outer sheath 12 may be at least 1 mm, between 1 and 3 mm, and in an embodiment does not exceed 4 mm. Furthermore, when viewed from the cross-sectional surface of the busbar 10, the outer sheath 12 has an area fraction of at least 20%, at least 35%, and in another embodiment at least 50%, wherein the remaining area fraction is determined by the cavity 13. It is not recommended to let the area fraction of the outer sheath increase above 70%, or even above 60%.

FIG. 2 shows a cross-section 20 of the rectangular busbar 10.2 with a wall thickness 16 of, in an embodiment, approximately 1 mm. An area fraction of the outer sheath 12 and an area fraction of the cavity 13 each amount to 50% of the total cross-section of the busbar 10 in the shown embodiment.

The cavity 13 of the busbar 10 contains at least one metal foam 14. The porosity of the metal foam 14, which is an inherent feature of the metal foam 14, is at least partially filled with a phase change material.

The metal foam 14 consists of an electrically and thermally conductive material, for example a metallic material based on copper or aluminum. This may include technical pure aluminum and copper alloys, but also alloys which reflect the previously described chemical composition of the outer sheath 12. Due to the manufacturing process of the metal foam 14, inclusions such as Al2O3, Mg-oxide, Ca-oxide, Ti-hydride, SiC particles may be present in the composition thereof. In an embodiment of the invention, the metal foam 14 has the same chemical composition as the surrounding outer sheath 12. In another embodiment, the outer sheath 12 consists of Cu or a Cu alloy, while the metal foam 14 consists of Al or an Al alloy. In a further embodiment, the outer sheath 12 consists of Al or an Al alloy, while the metal foam 14 consists of Cu or a Cu alloy.

Metal foams 14 can be manufactured by a plurality of methods. In a powder metallurgical method, for example, a metal powder is homogeneously mixed with a propellant powder, for example hydrides such as titanium hydride, and compacted into a precursor material. This can be done by uniaxial or isostatic pressing, powder extrusion, conform extrusion or thixocasting of powder compacts. Subsequently, if required, the starting material can be further processed using forming methods or machined, such as by milling. The precursor material is then heated to a temperature equal to or above the melting temperature of the metal powder. During this heating, the propellant agent releases a gas, which leads to the expansion and pore formation of the molten metal and thus to the generation of a metal foam. As soon as the maximum foam expansion is reached, the system or the metal foam 14 is cooled down and thus transferred to the solid phase.

This process can be carried out in suitable molds so that the expanding metal foam 14 takes on the inner contour of the mold. For example, the precursor material can be introduced into an extruded outer sheath so that the foaming process takes place directly inside the outer sheath 12. In this way, the busbar 10 can be manufactured as a uniform component with respect to the outer sheath 12 and the metal foam 14. It is understood that a busbar 10 manufactured in this way can undergo further processing steps, such as bending, pressing or cutting, before it is used as an electrically conductive component in a motor vehicle.

The near-net-shape metal foam 14 component can also be removed from the mold after cooling and, if necessary, further processed by a machining method. The finished, self-contained metal foam 14 can then be inserted into the hollow profile of the outer sheath 12, which has the final dimensions of the busbar 10. In this process, the metal foam 14 component is usually connected to the inner circumferential surface of the outer sheath 12, for example by melting or fusing to an inner coating, e.g. the above-mentioned tin coating, which solidifies under heat at the inner circumferential surface with the involvement of the metal foam component when it is introduced. However, it is also possible for the foam to be sandwiched between two plates or sheets and the outer sheath 12 to be created by welding or soldering additional plates or sheets around the foam 14. In this variant, too, within the scope of manufacturing the outer sheath 12, attention is paid to a direct, thus well heat-conducting connection between the plates/sheets and the metal foam 14 component, or else a well heat-conducting connection is made subsequently between the metal foam 14 component and the outer sheath 12. The foam can also be foamed in a mold and solidified to form the outer sheath 12, which can be formed, e.g., by condensing the expanded material forming the foam on the walls of the mold. Thus, the foam 14 and the outer sheath 12 are integrally produced.

Metal foams 14 can also be manufactured by foaming melts by gas injection. For this purpose, instead of adding gas-releasing propellant agents, gas is injected directly into the melt by a special impeller. The pores rising in the melt form a liquid foam on the surface of the molten bath, which is drawn off and solidifies. The investment casting method is also suitable for the production of metallic foam structures and can therefore also be used to produce the metal foams 14 used here.

Analogous to the metallic outer sheaths described above, an outer sheath of plastic, e.g., PTFE, polyimide or polyester, placed around the metal foam 14 can be brought into closer contact with it by an optional application of heat.

The metal foam 14 generally has pores extending in the longitudinal and transverse direction of the busbar 10, which may vary in size depending on the manufacturing process and may be self-contained or interconnected. In this context, a distinction is made between open-pored and closed-pored foam.

In an embodiment, the metal foam 14 completely fills the cavity 13 of the outer sheath 12. The metal foam 14 may also have at least one contact surface with the inner surface surrounding outer sheath 12. By creating such a contact between the outer sheath 12 and the metal foam 14, the latter can conduct part of the current flowing through the busbar 10 and thus positively influence the current-carrying capacity of the component. In addition, the metal foam 14 also conducts the heat energy generated by the current flow from the outer sheath 12 towards the innermost part of the busbar 10 and thus enables an improved or more uniform distribution of this heat energy throughout the busbar 10. Due to the large surface of the metal foam 14, which is in direct contact with the phase change material, more heat energy reaches the phase change material, resulting in better heat dissipation from the busbar 10.

In order to increase the number of contact areas between the inner surface of the outer sheath 12 and the metal foam 14 and/or to optimize these contact areas, heat treatments can be carried out on the busbar 10. It is understood that heat treatments can be carried out on the busbar 10 independently of the manufacturing process. The choice of the temperature and the duration of the heat treatment depends on the material of the outer sheath 12, the presence of optional surface coatings of the outer sheath 12 and the metal foam 14. For busbars 10 which are tinned, a temperature treatment between 230° C. and 400° C. is suitable. The duration of the treatment is defined by the size of the busbar 10. Through such treatments, the metal conductive connections between the metal foam 14 and the outer sheath 12 can be established and, if necessary, improved, possibly with melting of the inner coating of the outer sheath 12.

In order to further improve and homogenize the cooling effect of the busbar 10, it is additionally possible to maximize the amount of phase change material in the metal foam 14. Consequently, the phase change material (PCM) should fill at least 50% of the porosity of the metal foam 14, at least 60%, at least 80%, or at least 98%. From a filling ratio of 70%, the use of an open-pored foam with a pore size matched to the viscosity of the PCM is preferred. The portion of the porosity of the metal foam 14 filled with phase change material can be determined by visual analyses of corresponding cross-sectional surfaces.

The porosity of the metal foam 14 is composed of the sum of the voids or pores which are connected to each other and to the outermost surface of the metal foam (open porosity), and the voids or pores which are not connected to each other (closed porosity). In order to ensure fillability of the metal foam 14 with the phase change material, in an embodiment, the number of open pores are maximized and the number of closed pores are minimized in the metal foam 14. Accordingly, the metal foam 14 should have an open porosity of at least 30%, at least 50%, or at least 70%, wherein a complete open pore structure of the metal foam 14 is another embodiment of the invention. The porosity of the metal foam 14 can also be characterized by the pore size, the number of pores and their distribution. In an embodiment, the metal foam 14 has an approximately constant pore size. In an embodiment, the pores are homogeneously distributed over the entire metal foam 14.

The appropriate pore size and number of pores is determined by optimizing the proportion of metal foam 14 in relation to the proportion and type and chemical composition of the phase change material used. If the metal foam 14 is too porous and has only a minimal amount of metallic structure, the heat energy can be conducted more slowly from the outer sheath 12 into the busbar 10 interior to the phase change material. If, on the other hand, the porosity is too low, less phase change material is available to absorb the heat energy. Since the porosity of the metal foams 14 is characterized by the combination of pore number and pore size, this is strongly coupled to the PCM in the application and thus the area of use. Consequently, the metal foam 14 to be used has at least 10 pores per inch (PPI), 20 PPI, and, in an embodiment, a maximum of 45 PPI. The term PPI refers to the number of pores in a linear inch. Depending on the number of pores per inch (PPI), the average pore diameter is between 0.3-5 mm.

The porosity of the metal foam 14 can be determined, for example, by density measurements. The pore sizes and the number of pores of the metal foam 14 can be determined by metallographic microsections and subsequent evaluation programs, such as those used for grain size analysis.

Phase change materials are generally understood to be materials, the latent fusion heat of which is significantly greater than the thermal energy they can store due to their specific heat capacity. The phase change material thus provides a latent heat storage. In the case of phase change materials, a phase transition takes place when a certain phase change temperature is reached or exceeded. The phase transition does not have to be carried out completely by the phase change material, but can also take place only partially, for example, depending on the variation of the ambient temperature.

An example of a phase transition would be the change from a solid to a liquid phase. The phase change material thus increasingly liquefies or solidifies when a certain phase change temperature is exceeded and can absorb heat during this process, which is used to carry out this phase transition. If heat is then no longer supplied to the phase change material during the phase transition, or if the phase change material is cooled instead before it is completely liquefied, the phase transition does not take place completely and the phase change material again becomes increasingly solid and ultimately again passes completely into the solid phase. In other words, the phase change material can absorb heat energy as long as the phase transition has not been completed, that is, the phase change material has completely transitioned from a first phase or state of aggregation to a second phase or state of aggregation. If the phase change material cools down again in the second phase, it again transitions from the second to the first phase or state of aggregation, wherein heat is then released again accordingly.

The phase change material of the invention, in an embodiment, is configured such that the phase change temperature is between 40° C. and 130° C., and refers to a solid-liquid transition of said phase change material.

Phase change materials (PCMs) can be made from inorganic or organic compounds, wherein the latter are further classified into paraffin and non-paraffin materials. The phase change material according to the invention comprises an organic compound, in particular a paraffin. Furthermore, the invention comprises the use of biodegradable PCMs and thus the use of a non-paraffinic phase change material based on fatty acid or fatty acid ester or methyl ester. For sustainability reasons, palmitic acid-based or resin-based PCMs, such as benzoxazine or cardanol+amine, may be used. In special cases, inorganic compounds can also be used.

The phase change material can be introduced into the metal foam 14 by heating the phase change material to a temperature equal to or higher than the phase change temperature and introducing or infiltrating the liquid phase change material into the metal foam 14. Infiltration of the phase change material in the porosity of the metal foam 14 can be done under gravity, but additional pressure can also be applied. In an embodiment, the phase change material is not introduced into the metal foam 14 until it is within the outer sheath 12.

Furthermore, the invention also relates to an electrically operated motor vehicle with at least one busbar according to the invention in a current conduction path from a charging contact element to or in a battery module of the motor vehicle.

What is claimed is:

1. A busbar, comprising:
an outer sheath enclosing a cavity; and
a metal foam contained in the cavity, a porosity formed within the metal foam is at least partially filled with a phase change material.

2. The busbar of claim 1, wherein the metal foam is connected to the outer sheath.

3. The busbar of claim 1, wherein the outer sheath has a wall thickness of at least 1 mm.

4. The busbar of claim 1, wherein at least 60% of the porosity of the metal foam is filled with the phase change material.

5. The busbar of claim 4, wherein at least 80% of the porosity of the metal foam is filled with the phase change material.

6. The busbar of claim 5, wherein at least 98% of the porosity of the metal foam is filled with the phase change material.

7. The busbar of claim 1, wherein the porosity of the metal foam is at least 30% open-pored.

8. The busbar of claim 7, wherein the porosity of the metal foam is at least 50% open-pored.

9. The busbar of claim 1, wherein a minimum porosity of the metal foam is at least 10 pores per inch.

10. The busbar of claim 9, wherein the minimum porosity of the metal foam is at least 20 pores per inch.

11. The busbar of claim 10, wherein the minimum porosity of the metal foam is at least 30 pores per inch.

12. The busbar of claim 1, wherein the outer sheath is formed of a plastic.

13. The busbar of claim 1, wherein the outer sheath and/or the metal foam include copper, a copper allow, aluminum, or an aluminum alloy.

14. The busbar of claim 1, wherein the outer sheath and the metal foam consist of a same material.

15. The busbar of claim 1, wherein the phase change material has a phase change temperature between 40 and 130° C.

16. The busbar of claim 15, wherein the phase change material has only a solid-liquid transition around the phase change temperature.

17. The busbar of claim 1, wherein the phase change material is based on a paraffin.

18. The busbar of claim 1, wherein the phase change material is biodegradable.

19. An electrically powered motor vehicle, comprising:
a busbar in a current conduction path from a charging contact element to or into a battery of the electrically powered motor vehicle, the busbar includes an outer sheath enclosing a cavity and a metal foam contained in the cavity, a porosity formed within the metal foam is at least partially filled with a phase change material.
